(19) United States
(12) Patent Application Publication
(10) Pub. No.: US 2006/0027489 A1
(43) Pub. Date: Feb. 9, 2006

(54) 24-Volt pump adapter

(76) Inventor: Felix Libfeld, Long Meadow, MA (US)

Correspondence Address: ALIX YALE & RISTAS LLP, 750 MAIN STREET, SUITE 1400, HARTFORD, CT, 06103, US

(21) Appl. No.: 11/196,553

(22) Filed: Aug. 3, 2005

Related U.S. Application Data
(60) Provisional application No. 60/600,097, filed on Aug. 9, 2004.

(51) Int. Cl. B01D 35/18; F04B 49/06

(52) U.S. Cl. 210/180; 417/44.2

(57) ABSTRACT

An adapter connects a pump motor of a fuel filter assembly in series with a heater to a 24-volt electrical system. The heater and motor in series act as a voltage divider. The heater is selected so that the total resistance of the voltage divider provides current flow adequate to operate the pump motor. The motor resistance and the heater resistance are approximately equal, producing a voltage drop across each component of approximately 12 volts. With appropriately selected components, no additional electrical or electronic components or circuitry are required. Existing, proven 12-volt motors and heaters can be employed. The 12-volt electrical components of a fuel filter assembly are efficiently adapted to operate in a 24-volt electrical system.

### CROSS REFERENCE TO RELATED APPLICATIONS

This application claims the benefit of U.S. Provisional Application No. 60/600,097, filed Aug. 9, 2004.

### BACKGROUND OF THE INVENTION

1. Field of the Invention

The present invention relates generally to fuel filter assemblies employed in connection with internal combustion engines and, more particularly, to electrical connections for supplying power to electrical components of the filter assembly.

2. Description of the Related Prior Art

Internal combustion engines are equipped with a fuel filter assembly for the purpose of removing particulates and separating water from the fuel supplied to the engine. In diesel engines operated in cold weather environments the fuel filter assembly may be provided with a heater to dissolve wax crystals which form in the diesel fuel at low temperatures. The fuel filter assembly may also include an electric motor to drive a pump for pressurizing the fuel system leading feeding the fuel injection pump or unit pumps.

Typical motor vehicle electrical systems are 12-volt electrical systems. Some larger agricultural or construction vehicles have 24-volt electrical systems. The electrical connectors for 12 volt systems are typically different from those in 24 volt systems. In the 12-volt electrical systems the electric motor and heaters associated with a fuel filter assembly are 12-volt components connected to the vehicle electrical system in a conventional manner. 24-volt electrical systems usually require motors and/or heaters configured to operate at 24 volts DC. Occasionally it is desirable to employ 12-volt components in a 24-volt electrical system. This can be accomplished by adding electronic circuits such as a DC to DC converter between the electrical system and the 12-volt component. The additional electrical or electronic components complicate the fuel filter assembly add to the cost and detract from the reliability of the assembly.

There is a need in the art for a simple, inexpensive and robust means of providing 12-volt DC power to a pump motor of a fuel filter assembly in a 24-volt DC electrical system.

### SUMMARY OF THE INVENTION

An aspect of the present invention relates to connecting the pump motor of a fuel filter assembly in series with a heater. The heater and motor in series act as a voltage divider. The heater is selected so that the total resistance of the voltage divider provides current flow adequate to operate the pump motor. The motor resistance and the heater resistance are approximately equal, producing a voltage drop across each component of approximately 12 volts.

With appropriately selected components, no additional electrical or electronic components or circuitry are required. Existing, proven 12-volt motors and heaters can be employed. Thus, the 12-volt electrical components of a fuel filter assembly can be efficiently adapted to operate in a 24-volt electrical system.

### BRIEF DESCRIPTION OF THE DRAWINGS

FIG. 1 is a sectional view through a fuel filter assembly showing a heater compatible with the present invention;

FIG. 2 is a sectional view through a filter assembly equipped with a lift pump compatible with the present invention;

FIG. 3 is a front view, partially broken away, of a fuel filter assembly showing electrical connections between the lift pump and heater according to aspects of the present invention;

FIG. 4 is a side view of the fuel filter assembly of FIG. 3; and

FIG. 5 is a schematic representation of the electrical circuit including the motor and heater according to aspects of the present invention.

### DETAILED DESCRIPTION OF THE PREFERRED EMBODIMENT

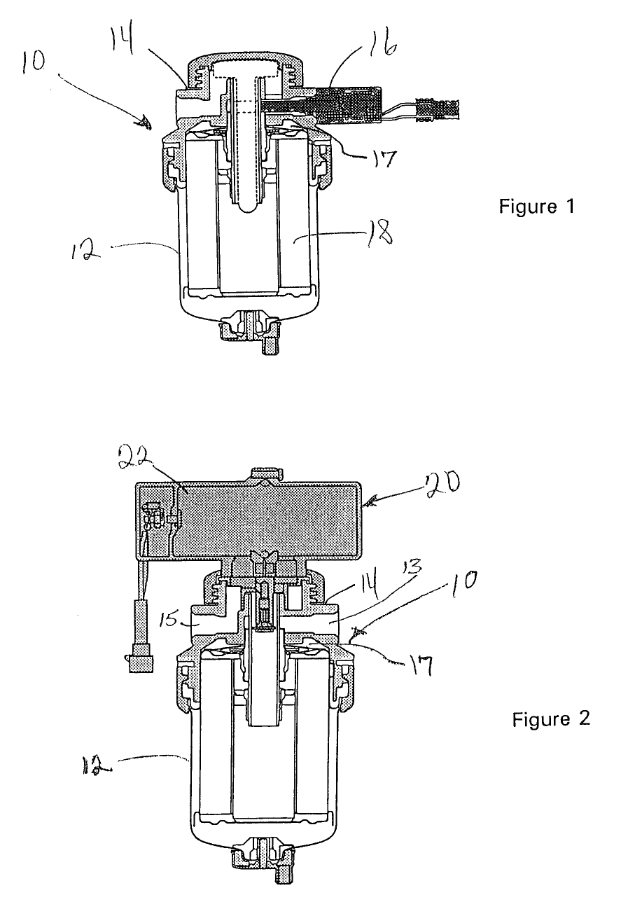

FIG. 1 illustrates a fuel filter assembly 10 in which a fuel filter cartridge 12 is suspended from a base 14 including fuel inlet and outlet passages and a heater 16 positioned to heat fuel flowing into the filter cartridge. The base defines inlet and outlet passages 13, 15, as shown in FIG. 2. The base also defines a cartridge receptacle 17 for receiving a filter cartridge 12. Together, the inlet and outlet passages and cartridge receptacle define a fluid flow path through the base. The heater 16 is an electrical resistance element that heats fuel on its way toward the filter media 18 to melt wax crystals that form in the fuel at cold temperatures. The heater 16 is mounted so that fuel entering the filter assembly passes over the heater to melt the wax crystals back into suspension immediately prior to the fuel entering the filter media 18.

FIG. 2 illustrates a fuel filter assembly 10 in which the base 14 is equipped with a lift pump 20. The lift pump 20 is driven by an electric motor 22 to pressurize fuel in the fluid flow path. The filter outlet communicates with the fuel injection pump or unit injectors (not shown). The lift pump increases the pressure at which fuel is delivered to the fuel injection pump or unit injectors. This increased delivery pressure helps speed engine starting and reduce emissions.

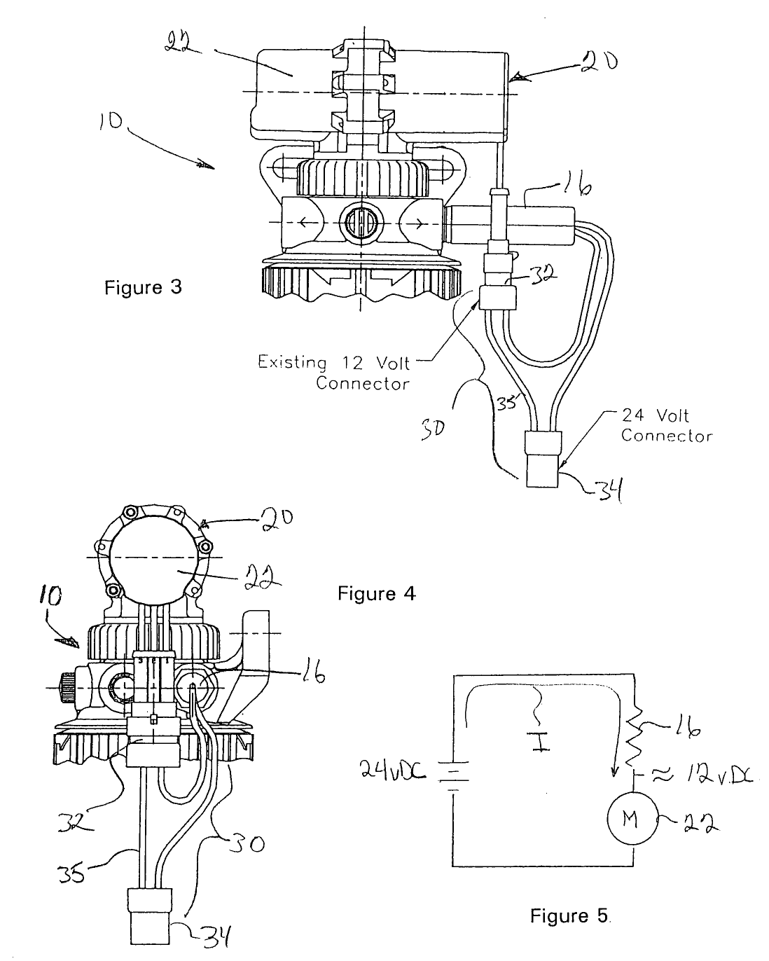

FIGS. 3 and 4 are partial views of a fuel filter assembly 10 equipped with both a heater 16 and a lift pump 20 according to aspects of the present invention. The illustrated pump motor 22 and heater 16 are 12-volt components. An exemplary form of a 24-volt adapter 30 connects the heater 16 and lift pump motor 22 in series and couples the connected components to a 24-volt electrical system by a 24-volt connector 34. In the illustrated configuration, the heater 16 is equipped with two electrical connectors 32, 34 and a conductor extending between the two electrical connectors. One of the connectors 34, is selected to be compatible with the 24 volt electrical system. The other connector 32, is selected to be compatible with an existing 12 volt connector on the pump motor. A conductor 35 connects one terminal of connector 32 to a terminal of connector 34. This modification to the heater 16 connects the heater and pump motor 22 to the 24 volt DC applied power in series when connector 32 is mated with the pump connector. It will be understood that the motor electrical connection could be modified in a similar manner. Alternatively, a Y adapter could be fabricated to accomplish the same connections.

The motor 22 and resistance heater 16 act as a voltage divider so that each component receives approximately 12 volts as shown in FIG. 5. Two conditions must be met for the illustrated configuration to function properly. First, the total resistance of the two components must permit a current I adequate for the pump motor 22. Second, the resistance of the heater 16 must be approximately equal to the resistance of the pump motor 22 so that the 24-volt supply voltage is divided approximately equally by the two components in series.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A fuel filter assembly adapted for operation in a 24-volt electrical system comprising:
a motor driven pump configured to operate at a first voltage and first current; and
a heater configured to operate at a second voltage and second current substantially equal to said first voltage and first current respectively,
wherein the motor for the pump and the heater are connected in series to the 24-volt electrical system.

2. The fuel filter assembly of claim 1, wherein said motor has a first resistance and said heater has a second resistance substantially equal to said first resistance.

3. The fuel filter assembly of claim 1, wherein said first voltage is approximately 12 volts DC.

4. The fuel filter assembly of claim 1, comprising a base defining a fuel inlet, a fuel outlet and a cartridge receptacle in fluid communication with said fuel inlet and fuel outlet, wherein said heater is mounted to said base to heat fuel entering through said fuel inlet before said fuel enters said cartridge receptacle.

5. A fluid filter assembly comprising:
a base defining a fluid flow path from a fluid inlet to a filter cartridge receptacle and a fluid outlet;
a fluid pump driven by an electric motor, said fluid pump mounted to the base in fluid communication with said fluid flow path; and
a resistance heater mounted to said base to heat fluid entering said fluid inlet before said fluid enters said cartridge receptacle,
wherein said electric motor and resistance heater are electrically connected in series, said electric motor and heater selected so that an applied voltage is divided substantially equally between said electric motor and resistance heater and a current through said electric motor and resistance heater allows said electric motor to drive said fluid pump.

6. The fluid filter assembly of claim 5, wherein said applied voltage is 24 volts DC and said electric motor and resistance heater are designed to operate at 12 volts DC.

7. The fluid filter assembly of claim 5, wherein said fluid pump is arranged to pressurize fluid in said fluid flow path.

8. A method for adapting a filter assembly to operate in a 24 volt DC electrical system, said base defining a fluid flow path between an inlet and an outlet and comprising an electric motor driven pump arranged to pressurize fluid in said fluid flow path and an electric heater arranged to heat fluid in said fluid flow path, said method comprising:
connecting said electric motor to the 24 volt DC electrical system in series with said electric heater; and
selecting said electric heater so that the total resistance of the electric motor and electric heater permits a series current through said electric motor that allows said electric motor to drive said pump.

9. The method of claim 8, wherein said electric heater and electric motor are selected to have approximately equal electrical resistance.

10. The method of claim 8, wherein each of said electric motor and electric heater have two supply wires and one of said electric motor or electric heater has a first electrical connector including terminals coupled to each of said supply wires, and said step of connecting comprises:
providing a second electrical connector compatible with the 24 volt DC electrical system, said second electrical connector having two electrical terminals;
providing a third electrical connector mateable with said first electrical connector, said third electrical connector having two electrical terminals;
connecting one electrical terminal of each said second and third electrical connector to one of said supply wires of the other of said electric heater or said electric motor; and
connecting a conductor between the other terminals of said second and third electrical connectors such that said electric heater is electrically connected in series with said electric motor when said third connector is mated with said first connector.

11. The method of claim 8, wherein said electric motor has a first electrical connector, said electric heater has two power supply wires and said step of connecting comprises:
providing a second electrical connector compatible with the 24 volt DC electrical system;
providing a third electrical connector compatible with said first electrical connector;
connecting said second electrical connector to one of said supply wires;
connecting said third electrical connector to the other of said supply wires; and
connecting a conductor between said second and third electrical connectors such that said electric heater is electrically connected in series with said electric motor when said third connector is mated with said first connector.
